(19) United States
(12) Patent Application Publication
(10) Pub. No.: US 2012/0026522 A1
(43) Pub. Date: Feb. 2, 2012

(54) GUI-IMPLEMENTATION PROGRAM, GUI-IMPLEMENTATION APPARATUS, AND METHOD OF GUI-IMPLEMENTATION

(75) Inventor: Shin IGAWA, Hino-shi (JP)

(73) Assignee: KONICA MINOLTA BUSINESS TECHNOLOGIES, INC., Chiyoda-ku (JP)

(21) Appl. No.: 13/178,070

(22) Filed: Jul. 7, 2011

(30) Foreign Application Priority Data
Jul. 27, 2010 (JP) 2010-168569

(51) Int. Cl. G06K 15/02

(52) U.S. Cl. 358/1.13

(57) ABSTRACT

A GUI implementation program stored in a non-transitory computer readable recording medium is a program for presenting at least one page of image on a preview screen based on a printing setup for a document comprising a plurality of pages be printed, and causing a computer to execute a process comprising the steps of determining a page turning direction based on a binding position specified as the print setup, which is a position for binding said document as a printed material; and implementing a GUI to the preview screen display, the GUI comprising the page forward turning button with a form to turn a page forward as well as the page backward turning button with a form to turn a page backward, and the GUI being positioned relative to each other according to said page turning directions.

### CROSS-REFERENCE TO RELATED APPLICATION

This application is based on Japanese Patent Application No. 2010-168569 filed on Jul. 27, 2010, the contents of which are incorporated herein by reference in its entirety.

### BACKGROUND

1. Technical Field

The present invention relates to a GUI-implementation program, a GUI-implementation apparatus, and a method of GUI-implementation, in particular related to GUI-implementation program, a GUI-implementation apparatus, and a method of GUI-implementation that enable page turning operations on a preview screen for a document with a plurality of pages.

2. Description of Related Art

Some of the PCs available on the market today are equipped with a function to display a preview screen as a utility used in printing for a user's convenience to check the expected appearance of a finished document by simulating such appearance based on the print setup of the document to be printed. Using this function, the user can check in advance how the finished document looks through the preview screen presented on the display and prevent oneself from ending up with a document that is different from what the user expected.

As an art of displaying a preview of a document printed on both sides of a page, there has been a technology of providing a turn operation button in order to turn a page horizontally or vertically to display the image to be printed on the back side of the page on the preview screen.

See Japanese Patent Publication No 2001-243041.

In case of a document where pages are turned left or right like a book, by pressing down the turn operation button, the user can turn a page horizontally to preview the image of the back of the page being displayed. Also, in case of a document where pages are turned upward or downward, by pressing down the turn operation button, the user can turn a page vertically to preview the image of the back of the page being displayed. Either for the horizontal turning or for the vertical turning, the turn operation button is provided for switching between the image of the front side page and the image of the back side page of the same sheet to be printed.

Also, there is another technology for displaying a preview of a document, wherein the user can glance a plurality of pages at once by displaying a plurality of pages aligned within a preview screen.

See Japanese Patent Publication No 2008-226050.

However, the technologies shown above lack operability of performing a page turning operation in accordance with the binding specification selected at the print setup for turning the pages to preview back and forth in the entire range of document to be printed.

### SUMMARY

The present invention is intended to solve the problems described above. That is, an object of one embodiment of the present invention is to provide a non-transitory computer-readable recording medium for storing a GUI implementation program, a GUI implementation apparatus, and a GUI implementation method for implementing a GUI with a page turning operability in accordance with a binding specification selected in a print setup for turning the pages to preview back and forth in the entire range of a document to be printed.

To achieve at least one of the aforementioned objects, a GUI implementation program reflecting one aspect of the present invention stored in a non-transitory computer readable recording medium is a GUI implementation program for presenting at least one page of image on a preview screen based on a print setup for a document comprising a plurality of pages to be printed, and causing a computer to execute a process comprising the steps of: determining a page turning direction based on a binding position specified as the print setup, which is a position for binding the document as a printed material; and implementing a GUI to the preview screen, the GUI comprising the page forward turning button with a form to turn a page forward as well as the page backward turning button with a form to turn a page backward, and the GUI being positioned relative to each other according to the page turning directions.

It is preferable in the above-mentioned non-transitory computer readable recording medium that the preview screen is presented on a touch panel; and the GUI is implemented so as to enable a page turning operation by a flick operation in which the user slides a finger parallel to the page turning direction on the touch panel and then removes the finger from the touch panel.

It is preferable in the above-mentioned non-transitory computer readable recording medium that the step of determining the page turning direction further comprises the steps of: determining whether or not the binding position is specified as the long side or the short side; determining which of the top, bottom, left or right side the binding position of the document is specified to by referring to the orientation of the printing paper specified as the print setup, when the binding position is specified as either a long side or short side; and determining the page turning direction to be upward or downward when the biding position is either the top side or the bottom side, or to be leftward or rightward when the biding position is either the left side or the right side.

It is preferable in the above-mentioned non-transitory computer readable recording medium that the step of determining the page turning direction further comprises the steps of: determining whether or not the binding position is specified as the top, bottom, left or right side; determining which of the top, bottom, left or right side the binding position of the document is specified to when the binding position is specified as either the top, bottom, left, or right side of the document; and determining the page turning direction to be upward or downward when the biding position is either the top side or the bottom side, or to be leftward or rightward when the biding position is either the left side or the right side.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the configuration of the PC related to the present embodiment.

FIG. 2 is a conceptual diagram showing a relation between an application program for displaying a preview screen, a printer driver, and a document preparing application program according to the present embodiment.

FIG. 3 is a diagram showing an example of print setup screens of the printer driver.

FIG. 4 is a flowchart for displaying the GUI on the preview screen according to the present embodiment.

FIG. 5 is a diagram showing a flowchart for determining a binding position.

FIG. 6 is a diagram showing a flowchart for determining a long side or short side binding position.

FIG. 7 is a diagram showing a flowchart for determining a page turning direction.

FIG. 8 is a diagram showing an example of operation buttons to be implemented based on a left bind or right binding position.

FIG. 9 is a diagram showing an example of operation buttons to be implemented based on a top bind or bottom binding position.

FIG. 10 is a diagram showing an example of a preview screen capable of previewing and page turning of a document which is specified to be bound on the left side.

FIG. 11 is a diagram showing an example of the preview screen shown in FIG. 10 after the first page has been turned.

FIG. 12 is a diagram showing an example of a preview screen capable of previewing and page turning of a document which is specified to be bound on the top.

FIG. 13 is a diagram showing an example of the preview screen shown in FIG. 12 after the first page has been turned.

### DETAILED DESCRIPTION

The embodiments of the present invention will be described in detail below with reference to the accompanying drawings.

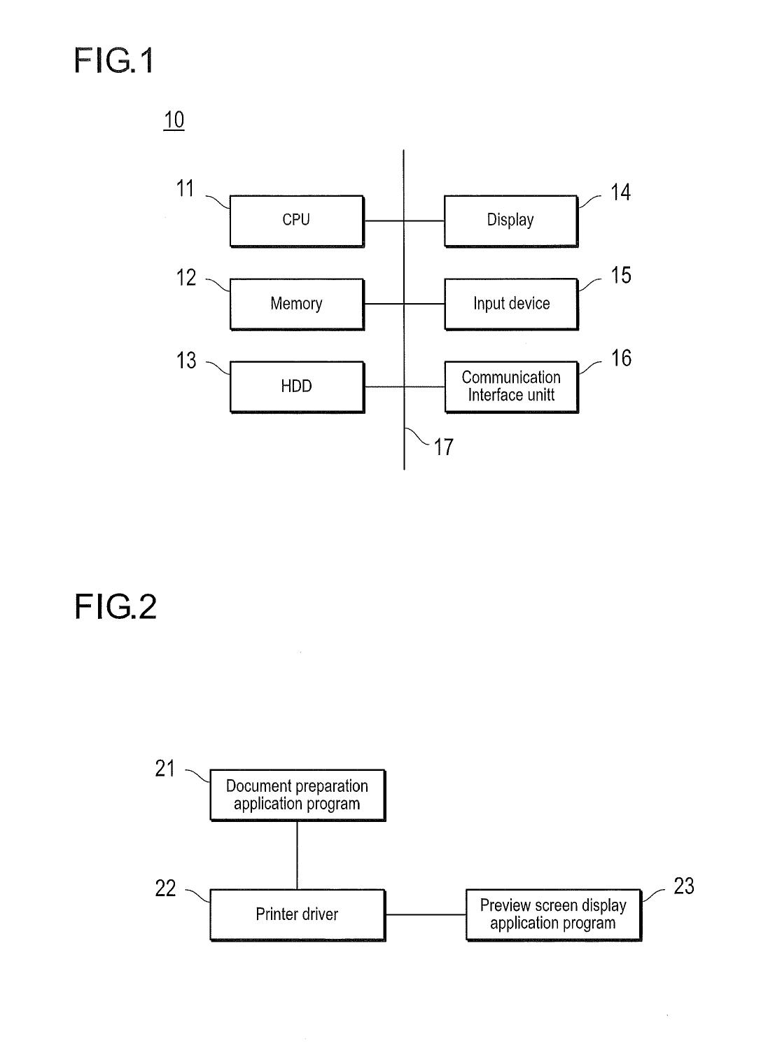

FIG. 1 is a block diagram showing the configuration of the PC related to the present embodiment. A PC (personal computer) 10 of the present embodiment is equipped with a CPU (Central Processing Unit) 11, a memory 12, a HDD (Hard Disk Drive) 13, a display 14, an input device 15, and a communication I/F (interface) unit 16, all of which is connected with each other via a bus 17 for exchanging signals.

The CPU 11 is in charge of performing various controls (e.g., control of a GUI: graphical user interface) and various arithmetic processes (e.g., a process of determining the page turning direction) to be executed according to programs.

The memory 12 consists of a ROM (Read Only Memory) in which various programs and various types of data are stored, a RAM (Random Access Memory) where the programs and data are temporarily stored as a working area, etc. Also, the memory 102 can consist of, for example, a DRAM (Dynamic Random Access Memory).

The HDD 13 stores various programs including the operating system and various types of data. For example, the HDD 13 is stored with a document preparation application program installed for preparing, selecting, and recreating document data, and preparing image data for printing based on the document data. It is also installed with a printer driver for converting prepared document data into PDL data described in PDL (Page Description Language) that can be interpreted by an MFP (not shown) including a printer, or for preparing various print setups. Moreover, the HDD 13 is installed with an application program for displaying a preview screen in order to check how a document intended to print looks like after finishing based on the print setup specified with the printer driver. Furthermore, the HDD 13 can store a plurality of types of image data prepared based on document data, and the stored image data can be loaded onto the memory 12 by the CPU 11 as needed and processed on the memory 12.

The display 14 is an OLED (Organic Light Eliminating Display), an LCD (Liquid Crystal Display), etc., and is used as a display unit for presenting various kinds of information. The display 14 can be constituted as a touch panel.

The input device 15 includes a pointing device such as a mouse or a keyboard, and it is used for entering various input data.

The communication I/F 16 is an interface for communicating with external equipment and can be constituted of a network interface based on standards such as Ethernet, Token Ring, FDDI, etc., a serial interface such as USB, IEEE 1394, etc., a parallel interface such as SCSI, IEEE 1284, etc., a wireless communication interface such as Bluetooth (registered trademark), IEEE 802.11, HomeRF, IErDA, etc., a telephone circuit interface for connecting with a telephone circuit, and the like.

The PC 10 may include components other than those mentioned above or may lack a portion of those components mentioned above.

FIG. 2 is a conceptual diagram showing a relation between an application program for presenting a preview screen, a printer driver, and a document preparation application program according to the present embodiment. A document preparation program 21 enables a user to prepare or edit a document file to be printed, and the prepared document file is read by the printer driver 22. The typical document preparation application program 21 includes Microsoft Word (registered trademark), Excel (trademark), and PowerPoint (trademark), as well as a dedicated application program.

A printer driver 22 can load document data related to a document file prepared by the document preparation program 21, and the user can specify various print setup related to the document file. Also, the printer driver 22 as a print setup unit converts the document data into a PDL such as PS (PostScript (trademark)), XPS (XML Paper Specification) and the like to generate PDL data based on the loaded document data as well as the print setup specified by the user. The generated PDL data is either read or referred to by a preview screen display application program 23. The detail of the print setup screen of the printer driver 22 will be described in detail later.

The preview screen presenting application program 23 loads the generated PDL data. The preview screen display application program 23 as a preview screen display unit presents on the preview screen how the finished document looks based on the loaded PDL data, describing the print setup specified with the printer driver 22. Simultaneously, the preview screen display application program 23 as the GUI implementation unit determines the page turning direction of the document based on the print setup. It then implements the GUI (operation buttons) on the preview screen for page turning operations based on the determined page turning direction. The detail will be described later. Here, the GUI according to the present embodiment is implemented on the screen as a visual user interface. Through such GUI, various inputs become possible by the user's clicking, dragging, and sliding operations on the screen. The GUI can be presented visually in such forms as buttons, scroll bars, dialog boxes, windows, etc.

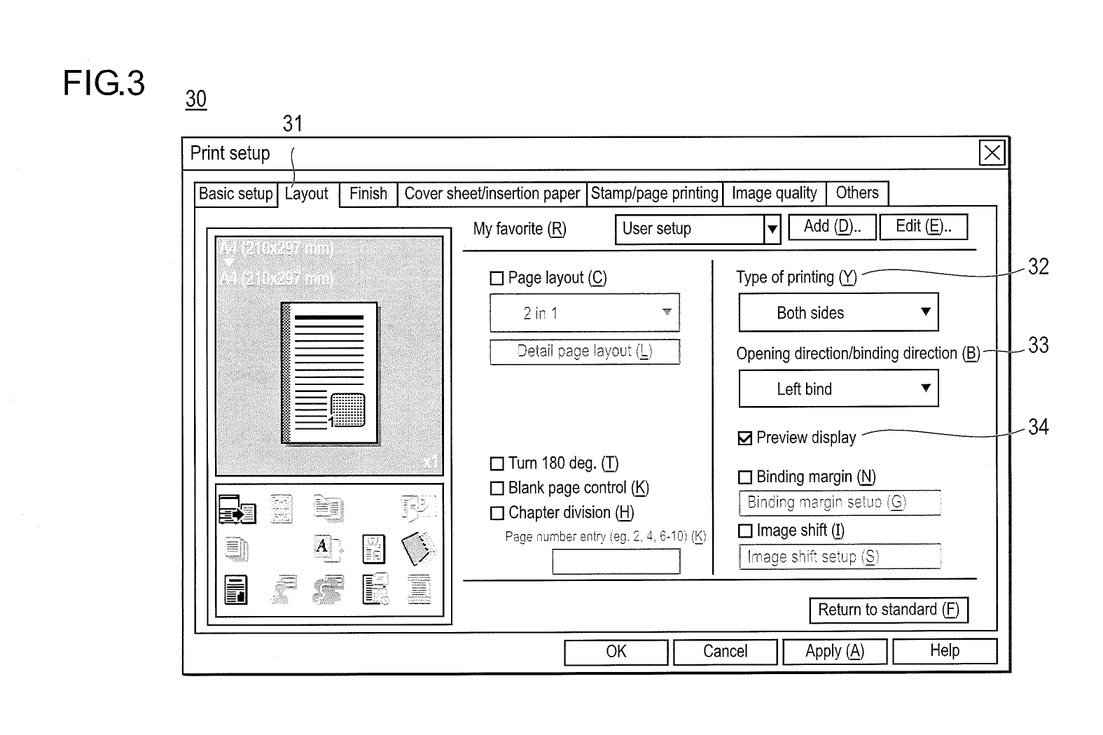

FIG. 3 is a diagram showing an example of print setup screens of the printer driver. A print setup screen 30 of a printer driver comprises different kinds of tabs each assigned for a different print setup purpose. By selecting a desired tab and entering input data related to the setup items comprised in the tab, various kinds of print setups can be specified. For example, by selecting a tab 31 provided for specifying “layout,” the setup screen shown in FIG. 3 is displayed. Various setup items are constituted in the setup screen of the tab 31 to specify the setups such as orientations for the image data of the document relative to printing paper. For example, “Printing Type” setup item 32 is constituted as an item to specify either one side or both sides of the printing paper to be used. In the setup item 32, the user can specify “Both Sides” or “Single Side,” etc.

Also, “Opening Direction/Binding Direction” setup item 33 is constituted in the setup screen of the tab 31 to specify the binding position of the printed material based on the document file. With regard to the setup item 33, the user can select a setup from “Left bind,” “Right bind,” “Top Bind,” “Bottom Bind,” “Long side Bind,” “Short side Bind,” etc. Here, the binding position is a position of the document to bind the printed material in a finishing process such as stapling.

Also, the setup screen in the tab 31 constitutes “Preview Display” setup item 34 for displaying a preview screen in order to check before printing how the document will look like after finishing. The user can make the preview screen visible on the display 14 by check-marking the setup item 34.

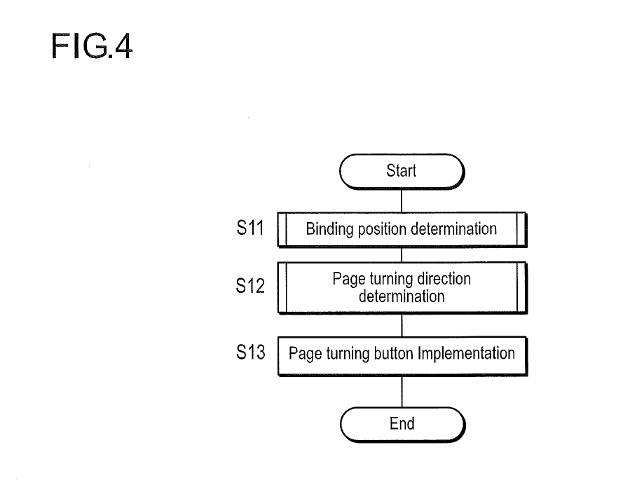

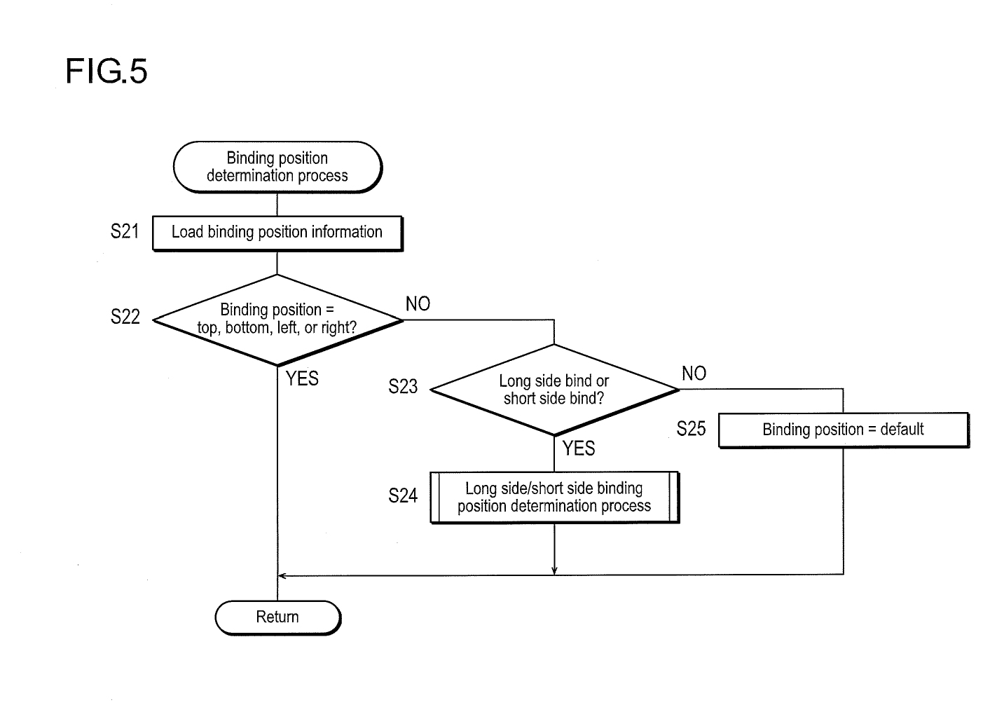

Hereafter, the process of implementing the GUI on the preview screen according to the present embodiment will be described in detail with reference to FIGS. 4 through 9.

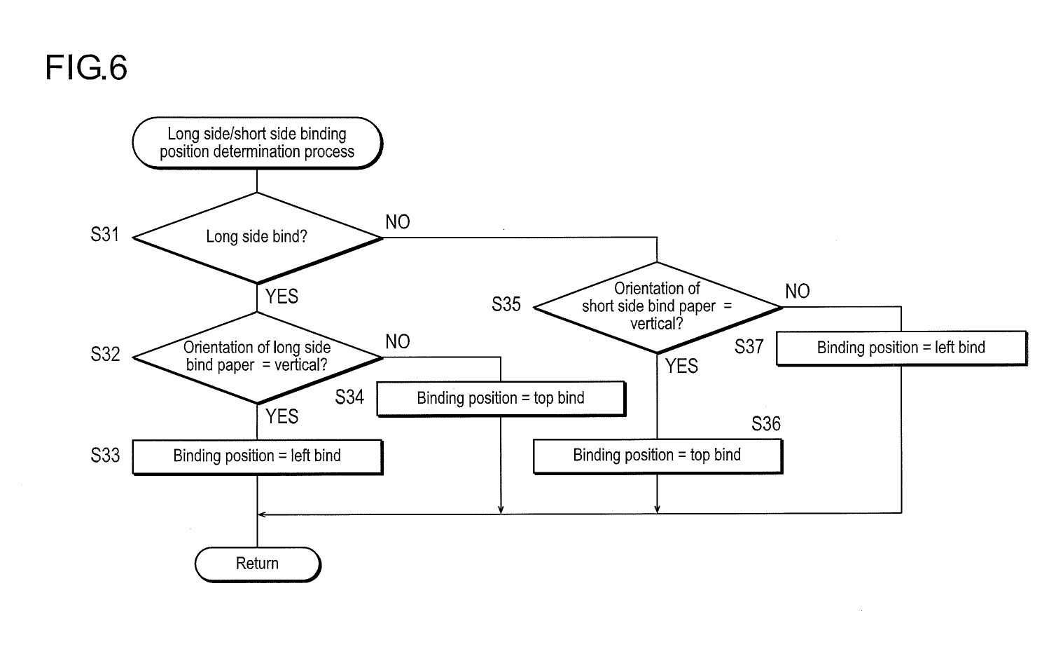

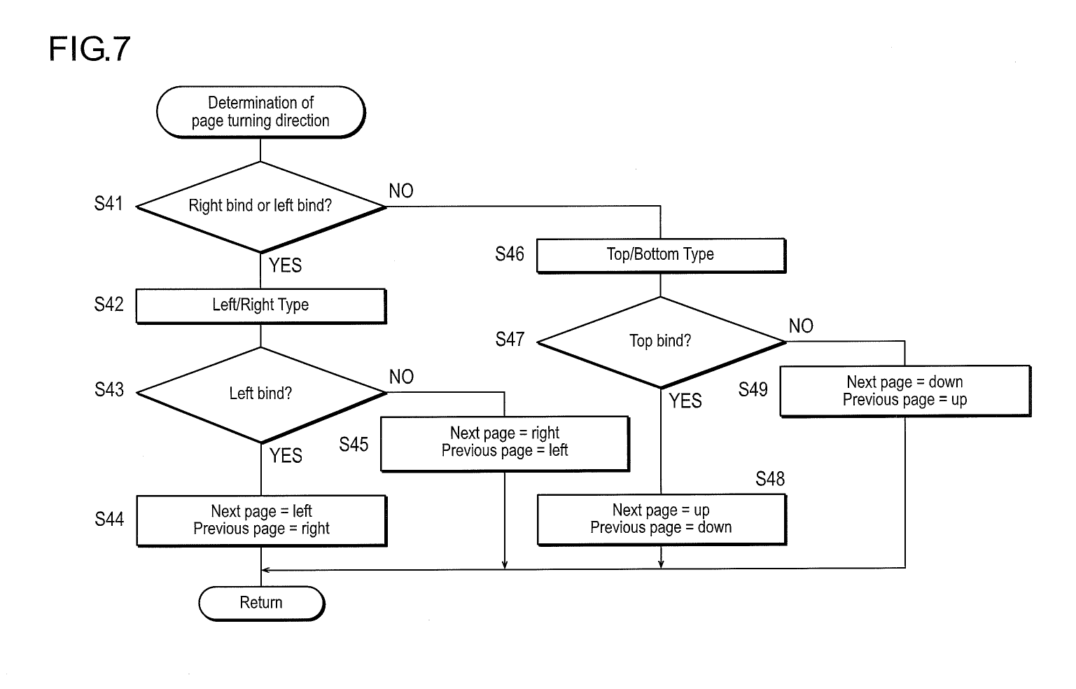

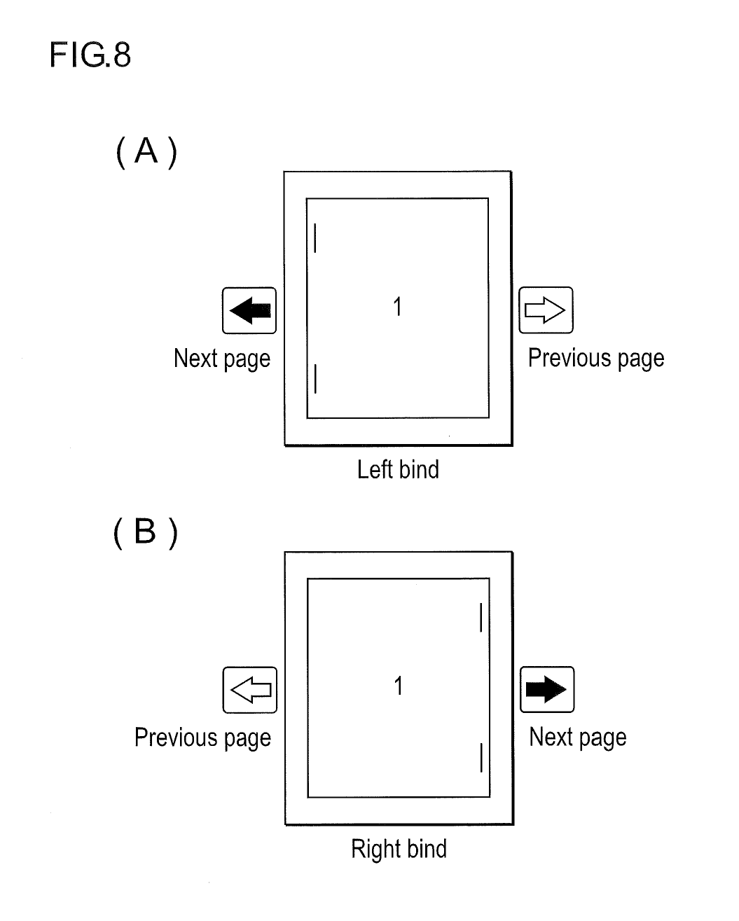

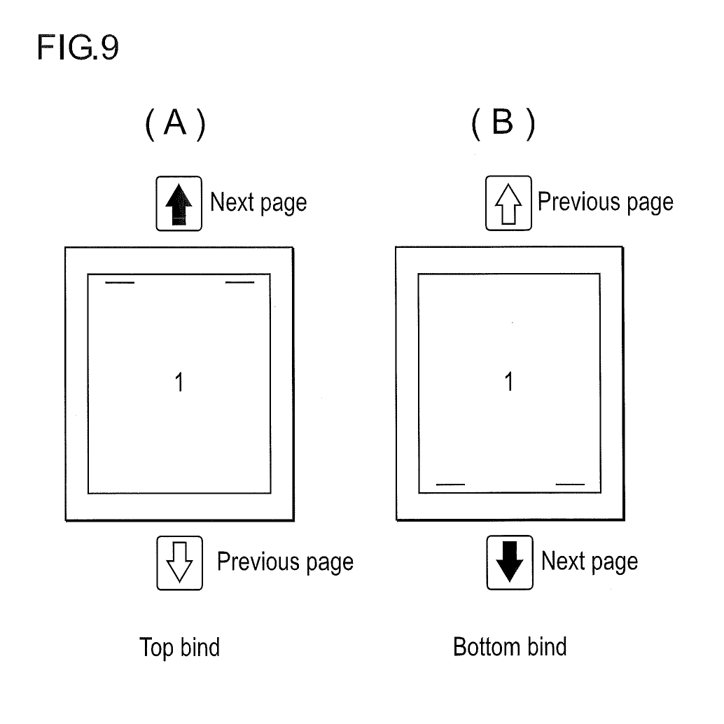

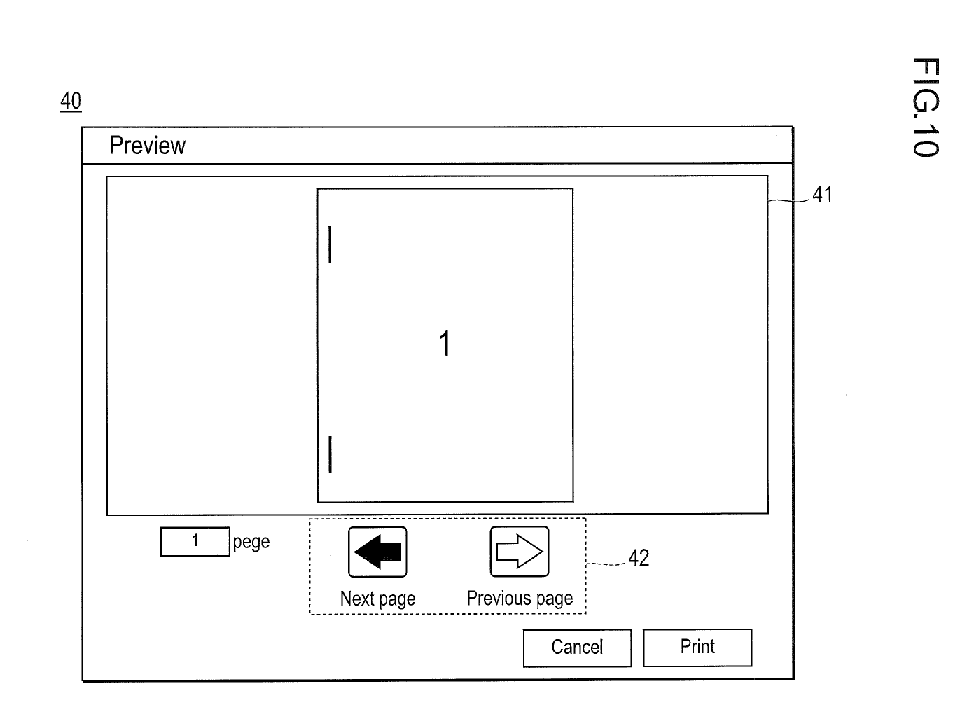

FIG. 4 is a flowchart for displaying the GUI on the preview screen according to the present embodiment, FIG. 5 is a diagram showing a flowchart for determining a binding position, FIG. 6 is a diagram showing a flowchart for determining a long side or short side binding position, FIG. 7 is a diagram showing a flowchart for determining a page turning direction, FIGS. 8 (A) and (B) are diagrams showing an example of operation buttons to be implemented based on a left bind or right binding position, and FIGS. 9 (A) and (B) are diagrams showing an example of operation buttons to be implemented based on a top binding or bottom binding position. The processes shown in the flowcharts of FIGS. 4 through 7 are executed by the CPU 11 of the PC 10.

In the present embodiment, the preview screen can be activated by entering a check-mark in the “Preview Display” setup item 34 as described above. More specifically, as the user dispatches a print instruction by pressing down (or clicking or touching) the print button (not shown), the preview screen is activated prior to performing printing by the printer. Simultaneously, the process of implementing the GUI on the preview screen is initiated.

(Binding Position Determination)

First of all, the binding position is determined (step S11). Here, the process shown in FIG. 5 is executed. First, the binding information is loaded (step S21). In this step, the PDL data generated by the printer driver 22 is loaded by the preview screen display application program 23 as described above.

Next, it is determined whether the binding position is top, bottom, left or right (step S22). In this step, whether or not the setup value concerning the binding position described in the loaded PDL data is specified as top, bottom, left, or right. More specifically, the setup for the “Opening Direction/Binding Direction” setup item 33 shown in FIG. 3 is converted to the PDL data as described above. Then, the preview screen display application program 23 interprets the setup value about the binding position by reading the PDL data. If the setup value concerning the binding position is either top, bottom, left or right (step S22: Yes), the process of the determining the binding position is terminated.

On the other hand, if the setup value concerning the binding position is neither top, bottom, left nor right (step S22: No), it is determined whether or not the setup value concerning the binding position is either long side or short side (step S23).

If either long side or short side is specified (step S23: Yes), the program advances to step S24.

On the other hand, if the setup value concerning the binding position is neither the long side nor the short side (step S23: No), the binding position is determined to be the default value (step S25). The default value of the binding position is, for example, “Left” or “Top.”

In step S24, the process of determining the binding position, for which either the long side or the short side was specified, is executed. Here, the process shown in FIG. 6 is executed. More specifically, first, it is determined whether or not the long side bind is specified or not, i.e., whether or not the biding location is specified along the long side of the printing paper (step S31). If it is determined that the binding position is not specified to be along the long side (step S31: No), the program advances to step S35.

On the other hand, if the binding position is specified to be along the long side (step S31: Yes), it is determined whether or not the direction of the long side binding is specified to the vertical direction in terms of the orientation of the printing paper (step S32). The setup concerning the direction of the printing paper can be specified, for example, in the “Paper Direction” setup item (not shown), which is a basic setup item of the printer driver 22. If the vertical direction is set as the direction of the long side binding paper (step S32: Yes), the binding position is assumed to be on the left side (step S33).

On the other hand, if the horizontal direction is specified as the direction of the long side binding paper (step S32: No), the binding position is assumed to be on the top side (step S34).

In step S35, it is determined whether or not the vertical direction is specified as the direction of the printing paper of the short side binding. If the vertical direction is specified as the direction of the short side binding paper (step S35: Yes), the binding position is assumed to be on the top side (step S36).

On the other hand, if the horizontal direction is specified as the direction of the short side binding paper (step S35: No), the binding position is assumed to be on the left side (step S37).

(Page Turning Direction Determination)

Next, going back to FIG. 4, the page turning direction is determined (step S12). Here, the page turning direction as the direction to turn a page as in the turning gesture is determined based on the binding position determined in step S11 as described above. More specifically, the process shown in FIG. 7 is executed. First, it is determined whether or not it is right bind or left bind (step S41). In this step, it is determined whether the binding position determined in step S11 is right bind or left bind. If the right bind or the left bind is specified (step S41: Yes), the page turning direction is determined to be “Left-Right Type” (step S42).

Next, it is determined whether or not the binding position is left (step S43). In this step, in order to determine the page turning direction to go to the next page on the preview screen, it is determined whether the binding position is left or right. If it is left bind (step S43: Yes), the page turning direction to go to the next page (page forward turning direction) is set to “Left,” and the page turning direction to go back to the previous page (page backward turning direction) is set to “Right” at the same time (step S44). On the other hand, if it is right bind (step S43: No), the page turning direction to go to the next page is set to “Right” and the page turning direction to go back to the previous page is set to “Left” at the same time (step S45).

If the binding position is specified to neither the right bind nor the left bind (step S41: No), the page turning direction is determined to be “Up-Down Type” (step S46).

Next, it is determined whether or not the binding position is top (step S47). In this step, in order to determine the page turning direction to go to the next page on the preview screen, it is determined whether the binding position is top or bottom. If it is top bind (step S47: Yes), the page turning direction to go to the next page is set to “Top,” and the page turning direction to go back to the previous page is set to “Down” at the same time (step S48). On the other hand, if it is bottom bind (step S47: No), the page turning direction to go to the next page is set to “Bottom,” and the page turning direction to go back to the previous page is set to “Top” at the same time (step S49).

(Operation Button Display)

Next, going back to FIG. 4, the page turning operation button (GUI) is implemented (step S13). In this step, the operation button for turning the pages on the preview screen is implemented based on the setup concerning the page turning direction for going forward or backward on the pages on the preview screen. For example, as shown in FIG. 8(A), if “Left bind” is specified as the binding position, an arrow operation button (page forward turning operation button) pointing left as the page turning direction to go to the next page as specified in step S44 is implemented. At the same time, an arrow operation button (page backward turning operation button) pointing right as the page turning direction to go back to the previous page is presented on the right side of the button pointing to left. Here, since there is no page before the first page, the operation button to go back to the previous page may be displayed but disabled, or undisplayed. Similarly, the operation button on the last page (not shown) to go to the next page may be disabled or, undisplayed.

On the other hand, if “Right bind” is specified as the binding position as shown in FIG. 8(B), an arrow operation button (page forward turning operation button) pointing right as the page turning direction to go to the next page is implemented as specified in step S45. At the same time, an arrow operation button pointing left as the page turning direction to go back to the previous page is presented on the left side of the button pointing right. Here, since there is no page before the first page, the operation button to go back to the previous page may be disabled, or undisplayed.

Also, if “Top Bind” is specified as the binding position as shown in FIG. 9(A), an arrow operation button pointing upward as the page turning direction to go to the next page is implemented as specified in step S48. At the same time, an arrow operation button pointing downward as the page turning direction to go back to the previous page is presented below the button pointing upward. Here, since there is no page before the first page, the operating button to go back to the previous page may be disabled, or undisplayed.

On the other hand, if “Bottom Bind” is specified as the binding position as shown in FIG. 9(B), an arrow operation button pointing downward as the page turning direction to go to the next page is implemented as specified in step S49. At the same time, an arrow operation button pointing upward as the page turning direction to go back to the previous page is displayed above the button pointing downward. Here, since there is no page before the first page, the operation button to go back to the previous page may be disabled, or undisplayed.

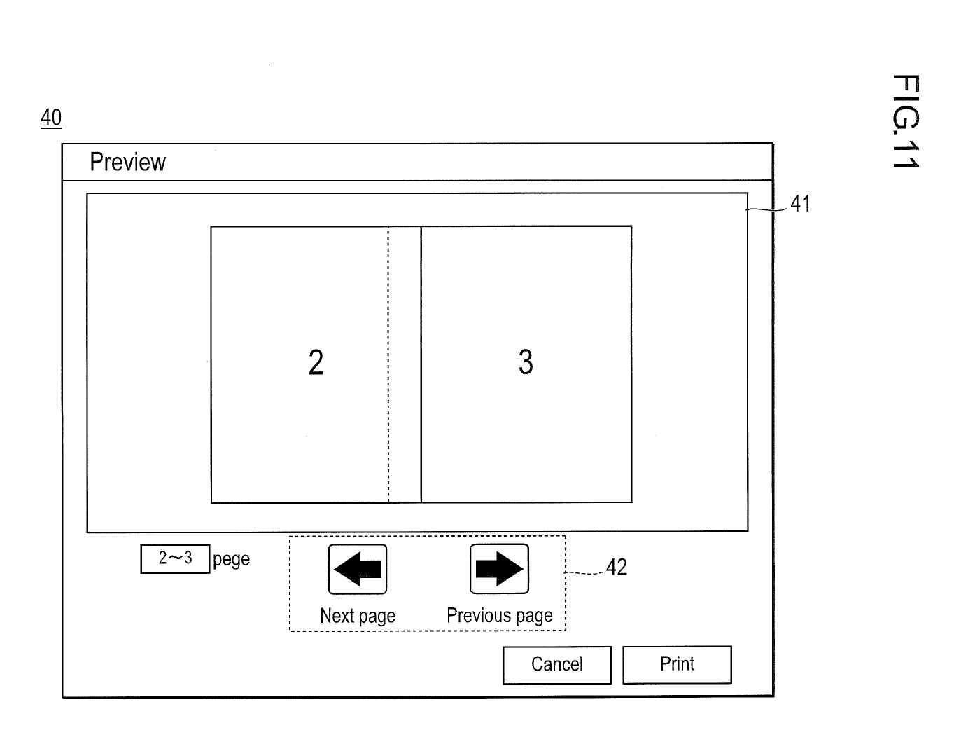

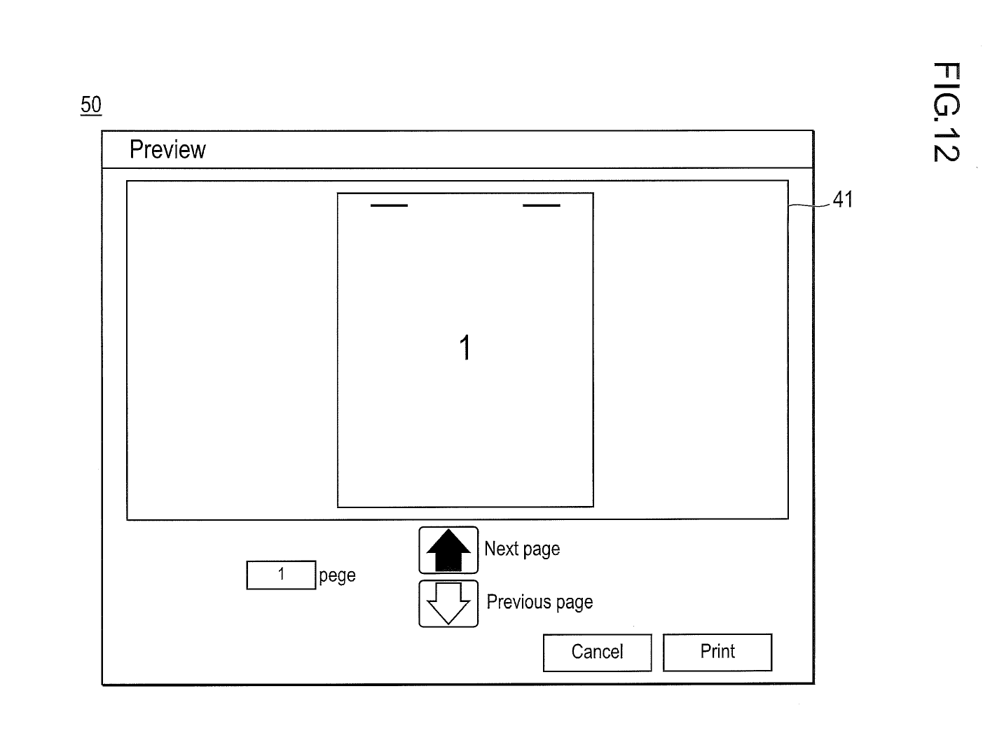

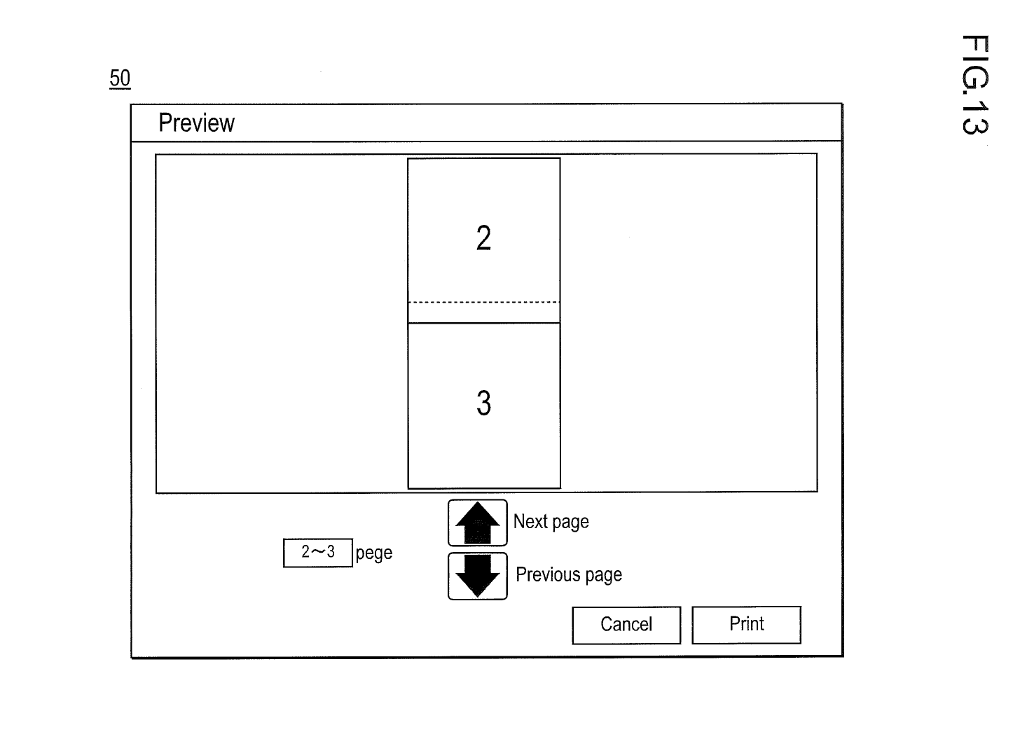

Examples of preview screens according to the present embodiment will be described below with reference to FIGS. 10 through 13. FIG. 10 is a diagram showing an example of a preview screen capable of previewing and page turning of a document which is specified to be bound on the left side, FIG. 11 is a diagram showing an example of the preview screen shown in FIG. 10 after the first page has been turned, FIG. 12 is a diagram showing an example of a preview screen capable of previewing and page turning of a document which is specified to be bound on the top, and FIG. 13 is a diagram showing an example of the preview screen shown in FIG. 12 after the first page has been turned.

With reference to FIG. 10, the preview screen 40 according to the present embodiment comprises a display unit for presenting how the finished document based on the print setup looks like, and a page turning operation button implementation unit 42, wherein such button is implemented based on the page turning direction. Such document is specified with the “Left bind” as the setup for the binding position. Here, a page would be turned from right to “left” in terms of a gesture to leaf through pages of a printed material if the document were printed. Therefore, the page turning operation button pointing left on the preview screen is implemented as a page forward turning button for presenting the next page. Also, since the display unit 41 is currently showing the first page and there is no page before the first page, not only the page backward turning button pointing right to return to the previous page is presented as being inoperable, but also its function as a GUI is disabled.

FIG. 11 shows the condition where the first page is turned on the preview screen 40 by pressing down the page forward turning button pointing left in order to go to the next page in FIG. 10. More specifically, an electrical signal related to pressing down the page forward turning button pointing left as a GUI is transmitted to the CPU 11. Receiving this electrical signal, the CPU 11 presents the next page on the display unit 41 of the preview screen 40 in accordance with the preview screen presenting application program 23. As the first page is turned, the second page and the third page appear. Also, the page backward turning button pointing right in order to return to the previous page is presented as being active, and its function as the GUI is enabled as well.

With reference to FIG. 12, the binding position of the document is set to “Top” binding. And, since the page is turned “upward” from the downside as in a gesture to leaf through the pages on the actual printed material, the page turning button pointing upward is implemented on the preview screen 50 as the page forward turning operation button. Also, since there is no page before the first page, not only the page backward turning button pointing right to return to the previous page is displayed as being inoperable, but also its function as a GUI is disabled.

FIG. 13 shows the condition where the first page was turned on the preview screen 50 in FIG. 12 by pressing down the page forward turning button pointing upward in order to go to the next page. The signal processing when the operation button is pressed proceeds as described above with regard to FIG. 11. By turning the first page, the second page and the third page are presented. Also, the page backward turning button pointing downward in order to return to the previous page is presented as being active, and its function as the GUI is enabled as well.

As described above, in the present embodiment, the page turning direction is determined based on the binding position. In addition, the page turning operation button (GUI) is implemented in accordance with the page turning direction. Thus, the user can simulate page turning on the preview screen. Therefore, the user can visually confirm the print setup in terms of the binding position by checking the operation button on the preview screen or operating such operation buttons, and thus can prevent mistakes in the print setup.

Also, although the direction to go to the next page is defined as the page turning direction in the above embodiment, the side on which the next page exists can be defines as the direction to go to the next page. In this case, the forward and backward directions shown on FIGS. 8 through 13 described in the above embodiment will be reversed. In this manner, it can be also configured such that the direction to go to the next page can be arbitrarily selected according to the user's convenience.

Meanwhile, the binding process that defines the binding position in the above embodiment includes stapling, punching, middle binding, and book making process.

Although the operation button is described as page turning GUI in the above embodiment, various other types of GUI can be implemented additionally. For example, the GUI according to the present invention includes such a page turning operation as the flick operation in which the user slides a finger parallel to the page turning direction on the touch panel and then removes the finger from the touch panel.

Furthermore, although the operation button indicated the direction for advancing the page by the arrow in the above embodiment, the present invention is not limited to it. The direction can be displayed by various images, e.g., a shape of a finger pointing the direction, a geometric shape, etc.

Also, when the binding position is specified as a long side or a short side, the binding position was determined as leftward or upward in steps S33, S34, S36, or S37 to determine the page turning direction based on the orientation of the printing paper. However, the present embodiment is not limited to it. The binding position can be set rightward or downward in those steps.

Although the display unit for presenting how the document looks if it were printed was constituted separate from the operation button implementation unit on the preview screen according to the above embodiment, the present embodiment is not limited to such separately presented or implemented embodiment. The display unit and the operation button implementation unit can be presented and implemented overlapping each other as one form, or presented and implemented side by side without overlapping.

Although a check box was used as the setup item to present the preview screen on the print setup screen, the present embodiment is not limited to it. It can be constituted from a button to activate the preview screen.

The means and method of conducting various processes in the computer according to the present embodiment can also be realized either by a dedicated hardware circuit, or by installing a program in the computer. The above program, for example, can be provided either by a computer readable recording medium such as a flexible disk or CD-ROM, or on-line via a network such as the Internet. In such a case, the program recorded on the computer readable recording medium is normally transferred to and stored on a storage unit such as a hard disk. Also, the above program can be either provided as a standalone application software program or can be built into the software as a part of the function for the print setup of the computer.

What is claimed is:

1. A non-transitory computer readable recording medium stored with a GUI implementation program for presenting at least one page of image on a preview screen based on a print setup for a document comprising a plurality of pages to be printed, and causing a computer to execute a process comprising the steps of:
determining a page turning direction based on a binding position specified as said print setup, which is a position for binding said document as a printed material; and
implementing a GUI to said preview screen, said GUI comprising the page forward turning button with a form to turn a page forward as well as the page backward turning button with a form to turn a page backward, and said GUI being positioned relative to each other according to said page turning directions.

2. The non-transitory computer readable recording medium claimed in claim 1, wherein
said preview screen is presented on a touch panel; and
said GUI is implemented so as to enable a page turning operation by a flick operation in which the user slides a finger parallel to the page turning direction on said touch panel and then removes the finger from said touch panel.

3. The non-transitory computer readable recording medium claimed in claim 1, wherein said step of determining said page turning direction further comprises the steps of:
determining whether or not said binding position is specified as a long side or a short side;
determining which of the top, bottom, left or right side said binding position of said document is specified to by referring to the orientation of the printing paper specified as said print setup, when said binding position is specified as either the long side or the short side; and
determining said page turning direction to be upward or downward when said biding position is either the top side or the bottom side, or to be leftward or rightward when said biding position is either the left side or the right side.

4. The non-transitory computer readable recording medium claimed in claim 1, wherein said step of determining said page turning direction further comprises the steps of:
determining whether or not said binding position is specified as the top, bottom, left or right side;
determining which of the top, bottom, left or right side said binding position of said document is specified to when said binding position is specified as either the top, bottom, left, or right side of said document; and
determining said page turning direction to be upward or downward when said biding position is either the top side or the bottom side, or to be leftward or rightward when said biding position is either the left side or the right side.

5. A GUI implementation apparatus comprising:
a display unit for presenting a screen;
a print setup unit to set up printing for a document to be printed;
a preview screen display unit for presenting at least one page of image on said preview screen presented on said display unit; and
a GUI implementation unit, that
determines a page turning direction based on a binding position specified as said print setup, which is a position for binding said document as a printed material comprising a plurality of pages; and,
implements a GUI to said preview screen, said GUI comprising the page forward turning button with a form to turn a page forward as well as the page backward turning button with a form to turn a page backward, and said GUI being positioned relative to each other according to said page turning directions.

6. The GUI implementation apparatus claimed in claim 5, wherein
said display unit is a touch panel; and
said GUI is implemented so as to enable a page turning operation by a flick operation in which the user slides a finger parallel to the page turning direction on said touch panel and then removes the finger from the touch panel.

7. The GUI implementation apparatus claimed in claim 5, wherein
in determining said page turning direction, said GUI implementation unit further
determines whether or not said binding position is specified as a long side or a short side;
determines which of the top, bottom, left or right side the binding position of said document is specified to by referring to the orientation of the printing paper specified as said print setup when said binding position is specified as either the long side or the short side; and
determines said page turning direction to be upward or downward when said biding position is either the top side or the bottom side, or to be leftward or rightward when said biding position is either the left side or the right side.

8. The GUI implementation apparatus claimed in claim 5, wherein
in determining said page turning direction, said GUI implementation unit further
determines whether or not said binding position is specified as the top, bottom, left or right side;
determines which of the top, bottom, left or right side said binding position of said document is specified to when said binding position is specified as either the top, bottom, left or right side of said document; and
determines said page turning direction to be upward or downward when said biding position is either the top side or the bottom side, or to be leftward or rightward when said biding position is either the left side or the right side.

9. A method of GUI implementation for presenting at least one page of image on a preview screen based on a print setup for a document comprising a plurality of pages to be printed, comprising the steps of:
determining a page turning direction based on a binding position specified as said print setup, which is a position for binding said document as a printed material; and
implementing a GUI to said preview screen, said GUI comprising the page forward turning button with a form to turn a page forward as well as the page backward turning button with a form to turn a page backward, and said GUI being positioned relative to each other according to said page turning directions.

10. The GUI implementation method claimed in claim 9, wherein
said preview screen is presented on a touch panel; and
said GUI is implemented so as to enable a page turning operation by a flick operation in which the user slides a finger parallel to the page turning direction on said touch panel and then removes the finger from the said touch panel.

11. The GUI implementation method claimed in claim 9, wherein said step of determining said page turning direction further comprises the steps of:
determining whether or not said binding position is specified as a long side or a short side;
determining which of the top, bottom, left or right side said binding position of said document is specified by referring to the orientation of the printing paper specified as said print setup when said binding position is specified as either the long side or the short side; and
determining said page turning direction to be upward or downward when said biding position is either the top side or the bottom side, or to be leftward or rightward when said biding position is either the left side or the right side.

12. The GUI implementation method claimed in claim 9, wherein said step of determining said page turning direction further comprises the steps of:
determining whether or not said binding position is specified as the top, bottom, left or right side;
determining which of the top, bottom, left or right side said binding position of said document is specified to when said binding position is specified as either the top, bottom, left, or right side of said document; and
determining said page turning direction to be upward or downward when said biding position is either the top side or the bottom side, or to be leftward or rightward when said biding position is either the left side or the right side.
